(19) United States
(12) Patent Application Publication
(10) Pub. No.: US 2009/0152004 A1
(43) Pub. Date: Jun. 18, 2009

(54) CABLE CLOSURE END CAP

(76) Inventors: Pierre Bonvallat, Cluses (FR); Zhiyong Xu, Shanghai (CN); Bin Lu, Shanghai (CN)

Correspondence Address: 3M INNOVATIVE PROPERTIES COMPANY, PO BOX 33427, ST. PAUL, MN, 55133-3427, US

(21) Appl. No.: 12/302,513

(22) PCT Filed: Jul. 7, 2006
(86) PCT No.: PCT/US2006/026289

§ 371 Date: Nov. 26, 2008

(30) Foreign Application Priority Data
Jun. 23, 2006 (CN) 200610095928.8

(51) Int. Cl. H02G 15/02

(52) U.S. Cl. 174/77 R

(57) ABSTRACT

An end cap (30) for sealing an end of a closure about a cable member directed therein. The end cap (30) includes a wall member (32) having a first surface (34), an exterior surface and an outer circumferential edge. A longitudinal port (40) extends through the wall member (32) from the first surface to the exterior surface. The port (40) has a transverse cross-sectional shape defined by first and second lobed portions (42, 44) joined at a waist (46), the cross-sectional shape of the port configured for receiving a cable assembly having a corresponding transverse cross-section.

### BACKGROUND

The present invention relates to cable enclosures, and in particular to end caps or seals that provide a sealing relationship between cables and the enclosure. The invention particularly concerns end seals used with cable assemblies having non-circular transverse cross-sections.

Cables, such as telecommunication cables, carry hundreds and sometimes thousands of insulated wires or optical fibers. Such cables are often used aerially and extend between supports above the ground. Aerial cables may be extended between supports such as poles by stringing a support wire (i.e., a “messenger”) in a catenary between two poles and then lashing a multi-conductor cable or fiber optic cable (single or ribbon fiber) to the messenger. When two or more cable ends are joined together, as when tapping into an extended length of cable, a splice is created. Generally, the splice is enclosed for protection from the environment, including protection against weather elements, animals, insects and so forth.

Structures adapted for enclosing portions of cables are frequently referred to as splice closures or, more generally, cable closures. Such closures are typically adapted to enclose therein at least two and sometimes more cable ends. As used herein, the term “cable end” and variants thereof refer to a portion of a cable having exposed telecommunication lines (i.e. connective wires or optical fibers) and any additional connecting devices involved. Cable closures generally comprise a re-enterable compartment or casing having first and second opposite ends. The casing may be elongate to enclose a length of the cable, and may have a cross-sectional shape that is cylindrical or any other suitable shape. Cables to be joined are directed into the casing through the end walls of the casing. At each of the casing end walls, sealing means are generally required to ensure an environmental seal around the cables (i.e., between the cables and the cable closure).

Generally, a plurality of features are desirable in a sealing system used in association with cable closure end walls. Generally, the seal system should be configured such that it can be readily mounted around, or removed from association with, a continuous cable. Due to its extended length, a cable often cannot be easily threaded through an aperture, and the seal system is therefore desirably adapted for mounting about a mid-portion of an already positioned cable. In addition, the seal system should be capable of accommodating a variety of sizes of cables to reduce the number and type of seals which must be kept in inventory.

Existing end seals have been developed for use with cables having substantially round or circular transverse cross-sectional shapes, which are relatively easy to seal. However, cables having non-circular transverse cross-sectional shapes are increasingly being used. In particular, there is a trend toward the use of self-supporting aerial cables. Self-supporting cables are reinforced with internal strength members to support their own weight, such that the cable can be installed in an aerial environment without the use of a messenger. One type of self-supporting cable is a so-called Figure-8 cables. Figure-8 cables are cables in which a messenger is run parallel with and adjacent to a cable core within a common plastic jacket which encloses both the core and the messenger wire. The transverse cross-sectional shape of the cable generally resembles a figure-8 shape, with the messenger portion of the cable forming one lobe, and the core portion of the cable forming another lobe. Figure-8 cables can be attached to supports by splitting the messenger from the cable and attaching the messenger with clamps and dead ends as with a normal steel messenger.

Sealing around a self-supporting cable such as a Figure-8 cable is difficult due to the transverse cross-sectional shape of the cable. In addition, cables having various combinations of cable core portion diameters and messenger portion diameters are available, making it difficult to provide a single solution meeting the requirements of many different cable sizes. Current solutions for sealing Figure-8 cables generally involve wrapping tape around the cable. Tape may be wrapped around the cable until a generally circular cross-section is achieved, such that sealing members intended for round cables may be used. Mastic tapes may be wrapped around the cable to fill gaps between the cable and the closure. However, use of tapes and the like is not convenient for field installation, and greatly increases the time required to complete the installation. In addition, every time the closure is re-entered, the old tape must be removed and new tape installed, thereby increasing the cost of reentry operations.

### SUMMARY

One aspect of the invention described herein provides an end cap for sealing an end of a closure about a cable member directed therein. In one embodiment according to the invention, the end cap comprises a wall member having a first surface, a second surface and an outer circumferential edge. A longitudinal port extends through the wall member from the first surface to the second surface. The port has a transverse cross-sectional shape defined by first and second lobed portions joined at a waist, the cross-sectional shape configured for receiving a cable assembly having a corresponding transverse cross-section therethrough.

Another aspect of the invention described herein provides an enclosure for a telecommunication cable having a plurality of telecommunication lines. In one embodiment according to the invention, the enclosure comprises a re-enterable compartment for retaining telecommunication line connection devices, the re-enterable compartment including an opening for receiving a telecommunication cable assembly. A sealing member is configured for forming a seal between the telecommunication cable assembly and the compartment opening. The sealing member comprises a wall member having a first surface, a second surface, and an outer circumferential edge configured to sealingly engage the compartment opening. A longitudinal port extends through the wall member from the first surface to the second surface. The port has a transverse cross-sectional shape defined by first and second lobed portions joined at a waist, the cross-sectional shape configured for receiving the cable assembly therethrough.

### BRIEF DESCRIPTION OF THE DRAWINGS

The present invention will be further described with reference to the accompanying drawings wherein like reference numerals refer to like parts in the several views, and wherein:

FIG. 1 is a perspective illustration of an aerial splice closure in use with a self-supporting cable and an exemplary embodiment of an end seal according to the invention.

FIG. 2 is an enlarged illustration taken generally along line 2-2 of FIG. 1, showing the exemplary end seal of FIG. 1 in side elevation positioned in the splice closure.

FIG. 3 is a perspective illustration showing the bottom of the exemplary end seal.

FIG. 4 is an exploded perspective illustration showing the bottom of the exemplary end seal of FIG. 3.

FIG. 5 is an exploded perspective illustration showing the top of the exemplary end seal of FIG. 3.

FIG. 6 is a bottom plan view of the exemplary end seal of FIG. 3.

FIG. 7 is a cross-sectional illustration of the exemplary end seal, taken along line 7-7 of FIG. 6.

FIG. 8 is a greatly enlarged cross-sectional illustration of the portion of FIG. 7 encircled by dashed line 8.

FIG. 9 is an isometric view of an exemplary figure-8 shaped conduit.

### DETAILED DESCRIPTION OF ILLUSTRATIVE EMBODIMENTS

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

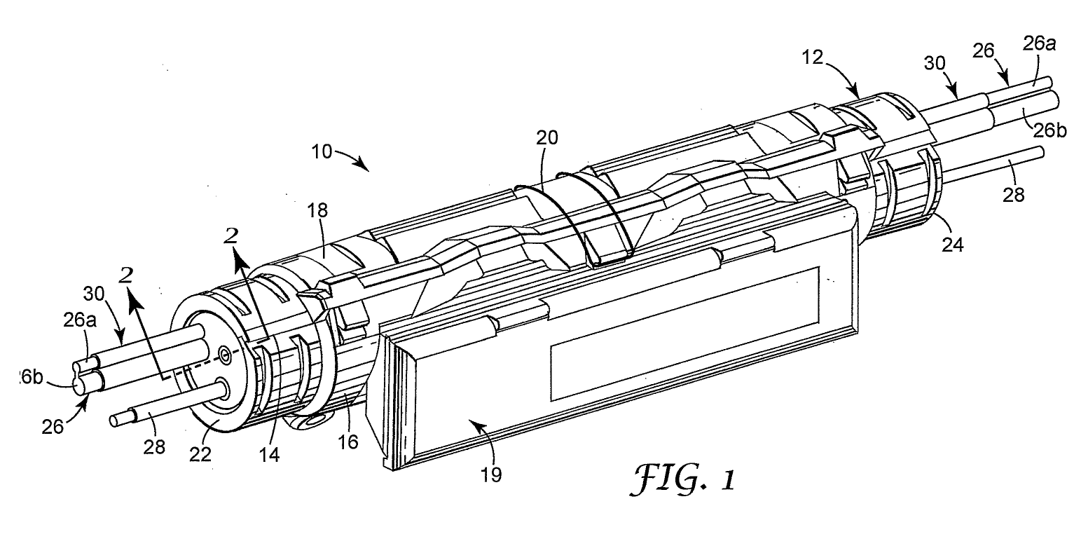

Referring now to FIG. 1, there is shown a splice closure 10 in which an end cap 30 according to the present invention is utilized. The exemplary splice closure 10 illustrated in FIG. 1 is a re-enterable aerial splice closure for retaining telecommunication line connection devices. It will be understood from the details described herein that end cap 30 according to the present invention may be utilized with a variety of closure systems, and splice closure 10 is only one exemplary environment. Splice closure 10 generally comprises casing 12 that may be opened along a seam 14 for access to an interior of casing 12. Generally, casing 12 includes a hinge (not shown) so that a bottom half 16 of casing 12 can be swung away from a top half 18 casing 12. Latches 20 provide for secure closure of casing 12. Generally, casing 12 is formed from a relatively rigid material such as plastic or metal. In one embodiment, casing 12 is made of plastic, so that it is readily formed, such as by blow molding although other molding technologies may be used for other closure designs, and is substantially resistant to damage from the environment. Optional terminal closure 19 is illustrated attached to splice closure 10. Terminal closure 19 may be used for fiber or copper drop termination applications. In another embodiment, closure 10 may be a two part closure (not joined by a hinge).

Still referring to FIG. 1, splice closure 10 is generally cylindrical and has first and second ends 22 and 24 respectively. For the embodiment shown, ends 22 and 24 are substantially identical, but are directed opposite one another. There is no requirement, however, that splice closure 10 have a shape as illustrated, or that ends 22 and 24 be so configured and arranged to make use of the invention. For the exemplary splice closure 10, an end cap 30 is positioned in each of the ends 22 and 24. Referring to end 22, which is in view in FIG. 1, self supporting cable 26 and distribution cable 28 are shown extending through end cap 30. In the illustrated embodiment, self-supporting cable 26 has a messenger portion 26a running parallel with and adjacent to a core portion 26b containing telecommunication lines therein, the portions 26a, 26b enclosed within a common plastic jacket. The transverse cross-sectional shape of self-supporting cable 26 generally resembles a figure-8 shape, with the messenger portion 26a of cable 26 forming one lobe of the cross-sectional shape, and core portion 26b of cable 26 forming another lobe of the cross-sectional shape. Cables 26 and 28, it will be understood, extend to a cable splice (not shown) enclosed within splice closure 10. In one embodiment, cables 26, 28 are telecommunication cables having a plurality of telecommunication lines (e.g., insulated conductors or optical fibers) therein. End cap 30 provides an environmental seal about cables, such as cables 26 and 28, extending therethrough and into closure 10. In one implementation, instead of self supporting cable 26, end cap 30 may be used with a cable assembly having a similar transverse cross-sectional shape, such as a lashed aerial cable which includes a telecommunications cable and a separate messenger to which the telecommunications cable is secured.

Alternatively, the end cap 30 can be used in conjunction with a figure-8 conduit. An exemplary figure-8 shaped conduit is commercially available (Silicore™ Figure-8 Self-Support Duct,Agents Private International Ltd., Ontario Canada or STRAND-GUARD® Flexcor Flexible Corrugated Aerial Figure-8 Conduit, ARNCO® Corporation, Elyria, Ohio). For example, FIG. 9 shows a typical structure of a figure-8 conduit 126 having a duct potion and a messenger portion 140 containing strength members 145. Figure-8 conduits can be used in air-assisted (blown) installed fiber optic communication systems. End cap 30 provides an environmental seal about conduit 126, extending therethrough and into closure 10 (not shown).

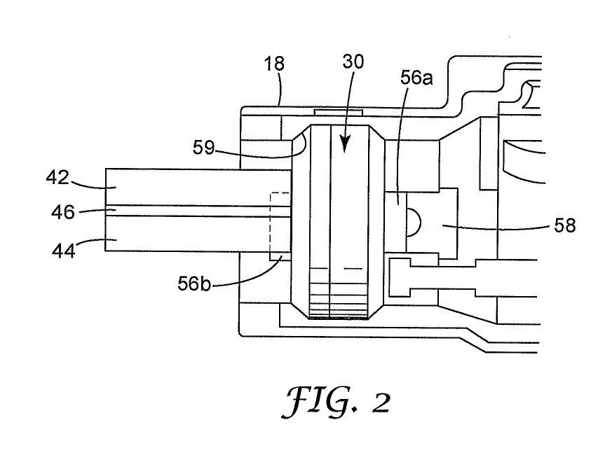

One exemplary embodiment of end cap 30 is illustrated in greater detail in FIGS. 2-8. In the exemplary embodiment of FIGS. 2-8, end cap 30 is configured to accommodate one self-supporting cable 26 and three auxiliary or distribution cables 28 passing therethrough (only one auxiliary or distribution cable 28 is illustrated). It will be understood that other end cap embodiments according to the present invention can be developed to accommodate various other numbers and style combinations of cable members.

End caps 30 according to the invention are not integrally formed with casing 12. That is, end caps 30 are generally removable from casing 12 and replaceable therein. An advantage to this is that an end cap 30 configuration appropriate for the particular installation (e.g., a configuration accommodating the desired number, shapes and/or sizes of cables passing therethrough) may be selected. Generally, end caps 30 according to the present invention can be formed in a single or two piece construction from a relatively soft rubber material, or a highly rubberized material. The materials forming end caps 30 are preferably capable of flexing and deforming under stress during use, such as to accommodate variations in size of the cables, or to accommodate movement of the cables relative to one another without substantial loss of seal. In one embodiment, the material forming end caps 30 is a thermoplastic rubber having a durometer not less than 40 Shore A hardness. One suitable thermoplastic rubber material is available from Advanced Elastomer Systems (AES) an affiliate of Exxon Mobil Corporation and sold under the trade designation Santoprene.

Referring to FIGS. 3-5, end cap 30 is an exemplary two piece construction that includes a wall member 32 having a first surface 34, a second surface 36 and an outer circumferential edge 38. Outer circumferential edge 38 is configured to sealingly engage casing 12 at ends 22, 24. A longitudinal port 40 extends through wall member 32 from first surface 34 to second surface 36. Port 40 has a transverse cross-sectional shape defined by first lobed portion 42 and second lobed portion 44 joined at a waist 46. The cross-sectional shape of port 40 is configured for receiving self-supporting cable 26 therethrough, and is generally complimentary to the transverse cross-sectional shape of cable 26 or conduit 126. In the illustrated embodiment, the cross-sectional shape of port 40 defines a substantially figure-8 shape, with first lobed portion 42 configured to receive messenger portion 26a of cable 26, and second lobed portion 44 configured to receive core portion 26b of cable 26. In one embodiment, first and second lobed portions 42, 44 comprise substantially circular shapes. Additionally, the illustrated embodiment shows the waist 46 as being a gap between the first and second lobed portions 42, 44. Alternatively, the hole 40 may contain a skin or membrane in the waist region to prevent entry of dust or humidity from entering the closure prior to installation of the support cable.

In the illustrated embodiment, end cap 30 further includes second, third and fourth longitudinal ports 50, 52, 54, extending through wall member 32. As best seen in FIG. 6, second, third and fourth ports 50, 52, 54, each have a substantially circular transverse cross-sectional shape configured for receiving a substantially cylindrical cable therethrough, such as a distribution cable. Second, third and fourth ports 50, 52, 54, may be configured to receive different sizes of cables.

In use, ports 40, 50, 52, 54 extend completely through end cap 30 for passage of cables 26, 28 therethrough. When end cap 30 is constructed, however, ports 40, 50, 52, 54 may be blocked or occluded by relatively thin pieces of material which are easily cut out to open the port. Additionally, the cut away region can be configured such that it is possible to select the size of the port created based on the size of cable which is to be inserted therethrough. Alternatively, the ports can be configured to accommodate a single cable construction. It will be understood that various numbers of ports may extend through end cap 30 according to the present invention, and that alternate arrangements of ports may be utilized in various applications.

In one embodiment, end caps 30 of the present invention are configured for mounting in casing 12 in such a manner that end caps 30 are properly positioned within casing 12 (e.g., first lobed portion 42 of port 40 is oriented toward the top of casing 12, such that splice closure 10 hangs from messenger portion 26a of cable 26 extending therethrough). In one embodiment, end caps 30 are retained in position within casing 12 even when casing 12 is opened along seam 14. Referring to FIG. 2, end cap 30 is shown positioned in the top half 18 of casing 12. End cap 30 includes locating means comprising first and second oppositely positioned mounting tabs 56a, 56b projecting from wall member 32 adjacent outer circumferential edge 38. Mounting tabs 56a, 56b are configured for engaging a mating element 58 in casing 12. As a result of engagement between mounting tabs 56a, 56b and casing 12, mounting tabs 56a, 56b properly position end cap 30 within casing 12 and tend to retain end cap 30 within casing 12, even if casing 12 is opened along seam 14. Mounting tabs 56a, 56b may engage casing 12 a snap-fit or friction-fit arrangement. Also referring to FIG. 2, it will be understood that end cap 30 is snugly received within annular recess 59 in casing 12 to facilitate secure mounting without substantial likelihood of end cap 30 moving longitudinally (i.e., movement along a longitudinal axis of casing 12 and provides needed compression against end cap 30 to provide adapted level of sealing in between end cap and closure body.

As best seen in FIGS. 3-5, in one embodiment, wall member 32 includes an interior wall section 60 and an exterior wall section 62 separably positioned against one another along interface 64, with interior wall section 60 defining first surface 34 of wall member 32 and exterior wall section 62 defining second surface 36 of wall member 32. Although interior and exterior wall sections 60, 62 are illustrated as completely separate components, in one embodiment sections 60, 62 may be joined by a connecting strap (not shown) to prevent loss or dropping of one of the sections. The terms “interior” and “exterior” when used with respect wall sections 60, 62 generally refer to whether the section or surface is positioned toward the inside or outside the closure when in use. The terms “interior” and “exterior” as used herein are meant only to refer to relative positions and/or orientations for convenience, and are not to be understood to be in any manner otherwise limiting.

Interior wall section 60 includes outer face 66 and inner face 67, while exterior wall section 62 includes outer face 68 and inner face 69. Outer face 66 of interior wall section 60 defines first surface 34 of wall member 32, and outer face 68 of exterior wall section 62 defines second surface 36 of wall member 32. Inner face 67 of interior wall section 60 and inner face 69 of exterior wall section 62 are positioned adjacent each other along interface 64. Interior wall section 60 and exterior wall section 62 include corresponding interior and exterior portions of ports 40, 50, 52, 54. Specifically, interior wall section 60 includes interior port portions 40a, 50a, 52a, 54a; while exterior wall section 62 includes exterior port portions 40b, 50b, 52b, 54b. The terms “inner” and “outer” when used with respect to faces of interior and exterior wall sections 60, 62 generally refer to whether the face is directed toward a mating section 60, 62 or away from a mating section 60, 62 during use. The terms “inner” and “outer” as used herein are meant only to refer to relative positions and/or orientations for convenience, and are not to be understood to be in any manner otherwise limiting.

In some installations, end seals 30 may be positioned close to a cut cable end, such that end cap 30 may be installed on the cable by threading the cut end of the cable through a selected one of ports 40, 50, 52, 54. In other installations, end seals 30 may not be positioned close enough to a cut cable end to permit threading the cable end through a port. For installations away from a cut cable end, selectively openable entrance slits 70 are provided to allow installation of cables into ports 40, 50, 52, 54. Selectively openable entrance slits 70 may initially be held closed by a relatively thin web of material, such that slits 70 define cut lines that may be selectively cut open by a knife, scissors or the like. Opened entrance slits 70 may be spread open or twisted to fit around a cable as the cable is introduced into a corresponding port.

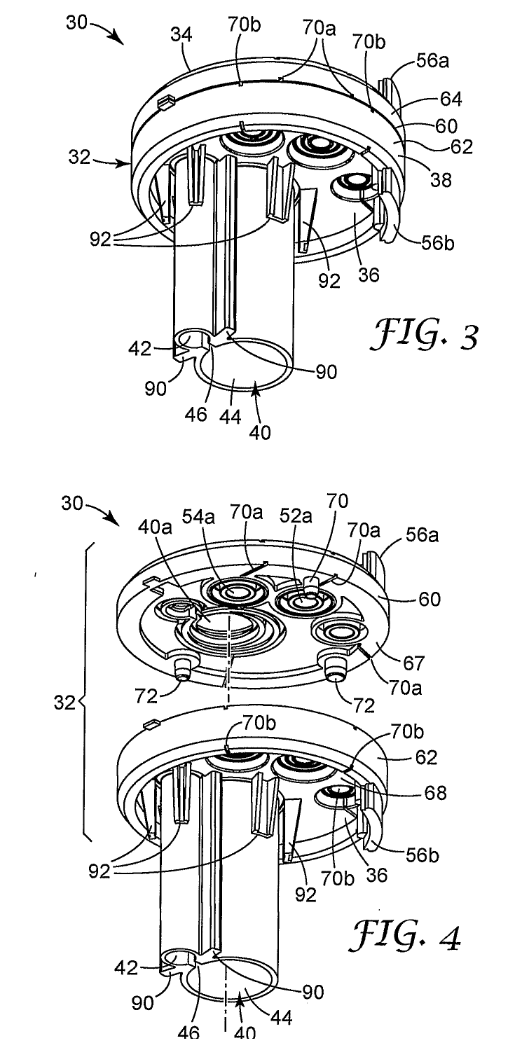

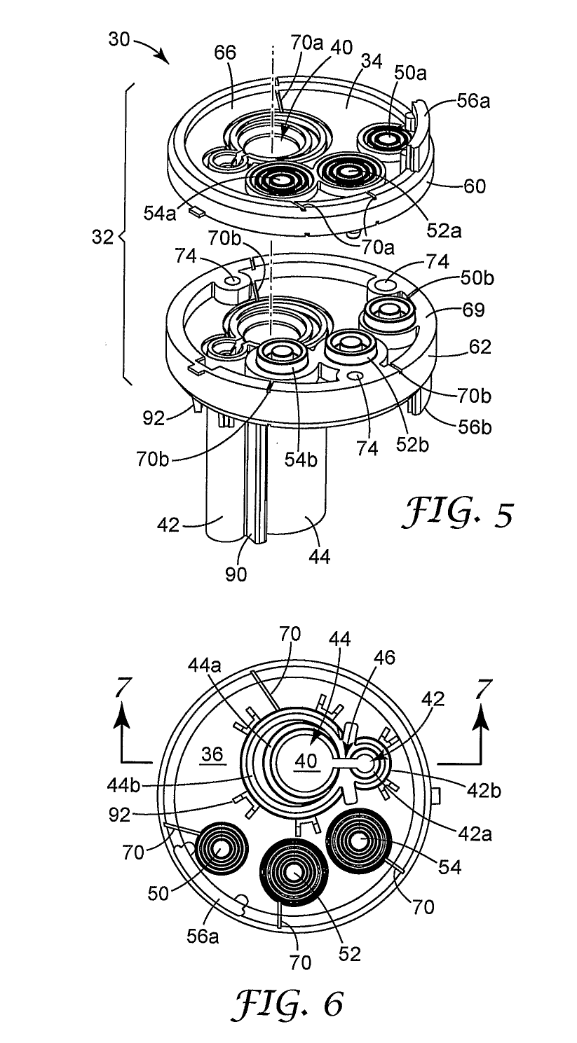

Referring now to FIGS. 4 and 5, selectively openable first cable entrance slits 70a extending from each interior port portion 40a, 50a, 52a, 54a to outer circumferential edge 38 are provided in interior wall section 60, and selectively openable second cable entrance slits 70b extending from each exterior port portion 40b, 50b, 52b, 54b to outer circumferential edge 38 are provided in exterior wall section 62. FIGS. 4 and 5 reveal that entrance slits 70a, 70b of each port do not extend at the same angle from the port to circumferential edge 38. Thus, when interior wall section 60 and exterior wall section 62 are positioned against one another, interior port portions 40a, 50a, 52a, 54a generally overlap and mate with, in a substantially co-axial manner, an associated exterior port portions 40b, 50b, 52b, 54b, but associated first and second cable entrance slits 70a, 70b of each port 40, 50, 52, 54 are not aligned with each other (best seen in FIG. 5). Because slits 70a, 70b are not aligned, the likelihood of leaks occurring completely through the end cap 30 along the slits 70 is reduced.

Referring to FIGS. 3-6, in one embodiment interior port portions 50a, 52a, 54a and exterior port portions 50b, 52b, 54b, are each formed as an arrangement of concentric rings. Each ring is defined by an alternating ridge/trough arrangement. When interior and exterior wall sections 60, 62 are formed, port portions 50a, 52a, 54a, 50b, 52b, 54b, are closed, i.e. not yet cut-out for use to extend the cable 28 therethrough. A variety of numbers of the concentric rings can later be cut out by shears, scissors or the like, or torn out by hand, to accommodate cables of various sizes. In one embodiment, ports 50, 52, 54 are formed according to the teachings of U.S. Pat. No. 4,822,954, commonly assigned herewith and incorporated herein by reference. In one embodiment, the alternating ridges/troughs of the interior and exterior wall sections 60, 62 are arranged such that ridges of interior wall section 60 are received in troughs of exterior wall section 62, and ridges of exterior wall section 62 are received in troughs of interior wall section 60. In this matter, mating and alignment between interior and exterior wall sections 60, 62 are facilitated.

Other means may be provided to facilitate mating and alignment of interior and exterior wall sections 60, 62. For example, a pin and aperture arrangement may be formed along interface 64. In one embodiment, one or more pins 72 are formed on inner face 67 of interior wall section 60, and corresponding recesses 74 are formed on inner face 69 of exterior wall section 62.

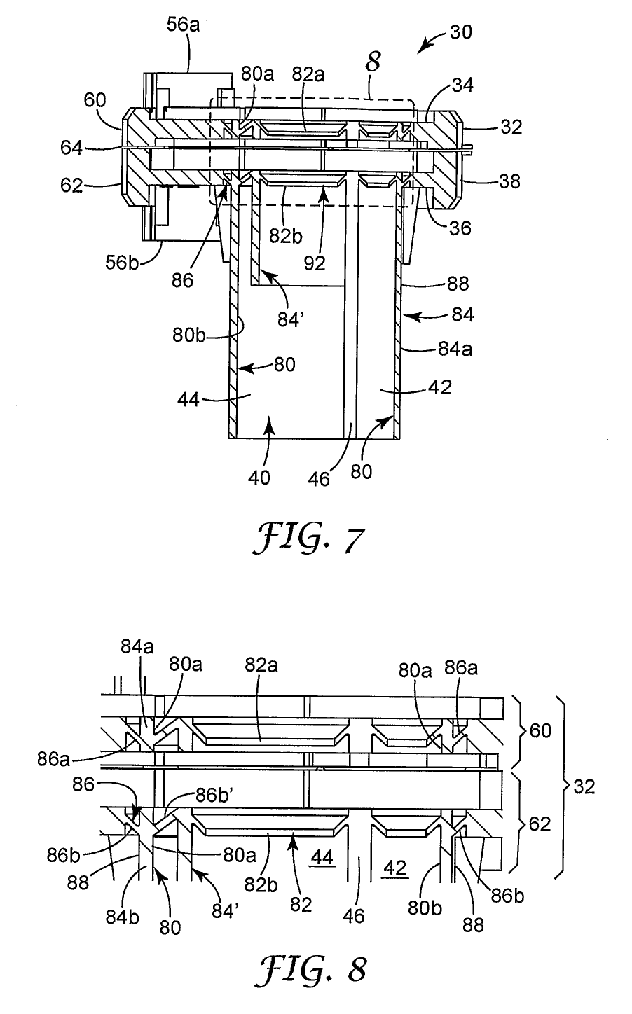

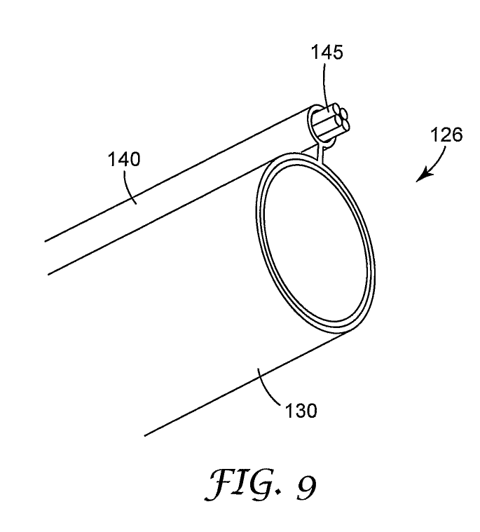

Referring now to FIGS. 7 and 8, port 40 configured for receiving self-supporting cable 26 therethrough is described. The lobed transverse cross-sectional shape of port 40 defines an inner surface or sidewall 80. At least one flexible sealing lip 82 is positioned within port 40 and projects from sidewall 80 around a periphery of at least one of the first lobed portion 42 and second lobed portion 44 of port 40. Increasing the number of sealing lips 82 provides redundancy in sealing against the environment. In one embodiment, a first flexible sealing lip 82a projects from sidewall 80a of interior wall section 60, and a second flexible sealing lip 82b projects from sidewall 80b of exterior wall section 62. In one embodiment, one or both of flexible sealing lips 82a, 82b angularly project from sidewall 80 toward second surface 36 of wall member 32. The angular orientation of sealing lips 82 provides improved ability to accommodate misalignment of the cable 26, or to accommodate a larger range of cable sizes. To further provide improved sealing, port 40 may extend beyond second surface 36 of wall 32 and/or beyond first surface 34 of wall 32 to thereby lengthen the distance contaminants (e.g., water, dust, insects, and the like) must travel to breach end cap 30 and minimize the amount of such contaminants that reach sealing lips 82. In one embodiment, port 40 extends about 60 mm from the second surface 36 of end cap 30. This distance generally provides adequate protection and allows sufficient room for an optional cable tie to be installed. Increasing the length of port 40 provides the additional benefit of improved strain relief for cable 26.

In one embodiment, and as best seen if FIG. 8, port 40 is defined by a hollow elongate member 84 extending through and suspended within wall member 32 by a flexible transverse skirt 86 extending from an outer surface 88 of the hollow elongate member 84 to the wall member 32. In the illustrated embodiment, elongate member 84 includes interior portion 84a suspended within interior wall section 60 by flexible transverse skirt 86a, and exterior portion 84b suspended within exterior wall section 62 by flexible transverse skirt 86b. As best see in FIG. 6, the transverse cross section of the flexible transverse skirt 86a, 86b and the flexible sealing lip 82a, 82b are zigzagged engaged to further improve the sealing feature.

In one embodiment, transverse skirts 86a, 86b and flexible sealing lips 82a, 82b, respectively, are circumferentially aligned with each other. To provide improved dimensional range and flexibility of both sealing lips 82 and skirts 86 sealing lips 82 and skirts 86 may be longitudinally offset, relative to the plane of wall 32. In one embodiment, flexible sealing lips 82 and skirts 86 are both angularly inclined relative to the plane of wall 32. Sealing lips 82 and skirts 86 may be inclined in the same or opposite directions.

As best seen in FIG. 6, to accommodate a range of sizes of self-supporting cables 26, in one embodiment interior port portion 40a and exterior port portion 40b are each formed with an arrangement of first and second lobed portions 42a, 42b, 44a, 44b having increasing sizes. The lobed portions 42a, 44a defining the smallest size of port 40 are open, and material may optionally be cut out by shears, scissors or the like, to increase the size of port 40 to that defined by larger lobed potions 44b. In many applications, such as small diameter of figure-8 shaped cable, the messenger 26a of different cables 26 are regarded to have the same diameter, therefore, the diameter of the lobed portions 42a only need to use the uniform dimension of diameter. Under these conditions, the lobed portions 42a (for the messengers to pass through) having the uniform dimension of diameter and the lobed portions 44a, 44b (for the core portions to pass through) having variable size of diameter could accommodate the self-supporting cables of different dimensions. Furthermore, sealing lips could be added along waist 46 to improve sealing features according different cable waist dimensions and the sealing lips may have variable dimensions to fit the different waist 46 of cables. It should be noted that the lobed portions 42a could use the similar matter as lobed portions 44a and 44b, being composed of lobed portions having different dimensions with materials covering the large lobed portions.

In the illustrated embodiment, port portion 40a extending from exterior wall section 62 includes elongate member 84′ (FIG. 7). Elongate member 84′ corresponds to the port size defined by second lobed portion 44a, and is suspended within elongate member 84 by flexible transverse skirt 86b′. Elongate member 84′ is removed when the size of port 40 in enlarged to the size defined by larger second lobed potion 44b.

Referring now to FIGS. 3-5, the hollow elongate member 84b extending from exterior wall section 62 optionally includes a support member 90 at waist 46 longitudinally extending along outer surface 88. Support member 90 provides rigidity at waist 46 and aids alignment of cable 26 within port 40. Additional sealing force against cable 26 may be applied by the installation of a cable tie or the like (not shown) over elongate member 84 adjacent second surface 36 of wall 32. Positioning members 92 may be provided on second surface 36 and spaced around elongate member 84 to aid in properly positioning a cable tie. Wall 80 could be longitudinally cut to provide adjustment to cable diameter, mainly in case small figure-8 shaped cable dimensions are used in hole 44. For example, as shown in FIG. 6, longitudinally cut means remove the side wall of the smaller port portion 40a so as to use the larger port portion 40b.

In use, end cap 30 is installed on self-supporting cable 26 by first opening entrance slits 70a, 70b of interior and exterior wall sections 60, 62, respectively, that extend into port 40. If port 40 is configured to accept different sizes of self-supporting cables 26, material may be removed from port 40 to obtain the desired port size. Self-supporting cable 26 is then passed through opened slits 70a, 70b into port 40. A cable tie or the like is optionally installed over elongate member 84 adjacent second surface 36 to aid in sealing against the surface of cable 26 as well as providing strain relief for cable 26. If one or more distribution cables 28 are to be installed, ports 50, 52, 54 are opened as needed by cutting appropriate entrance slits 70a, 70b and/or removing material to obtain the desired port diameter(s). Distribution cables 28 are then installed in one or more opened ports 50, 52, 54. Interior wall section 60 and exterior wall section 62 are mated and the assembled end cap 30 is installed in recess 59 of casing 12, using mounting tabs 56a, 56b as described above. These operations are completed for each end 22, 24 of closure 10, after which the installation is finished.

To re-enter closure 10, such as to install an additional distribution cable 28, it is only necessary to open closure 10 along seam 14, pull the end seals 30 with cables 26, 28 therethrough from casing 12. Interior and exterior wall sections 60, 62 are removed from the cables 26, 28, new cuts into ports 50, 52, 54 are opened as needed, and the end seals 30 are re-installed as described above. The end seals 30 are re-used, and the only additional material that may be required are one or two cable ties.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An end cap for sealing an end of a closure about a cable or conduit member directed therein, the end cap comprising:
a wall member having a first surface, a second surface and an outer circumferential edge; and
a longitudinal port extending through the wall member from the first surface to the second surface, the port having a transverse cross-sectional shape defined by first and second lobed portions joined at a waist, the cross-sectional shape configured for receiving a cable assembly having a corresponding transverse cross-section therethrough.

2. The end cap of claim 1, wherein the first and second lobed portions joined at a waist define a substantially figure-8 shape.

3. The end cap of claim 1, wherein the wall member comprises an interior wall section defining the first surface and an exterior wall section defining the second surface, the interior wall section and the exterior wall section positioned against one another.

4. The end cap of claim 3, further comprising:
a first cable entrance slit in the interior wall section, the first entrance slit extending from the port to the outer circumferential edge;
a second cable entrance slit in the exterior wall section, the second entrance slit extending from the port to the outer circumferential edge;
wherein when the interior wall section and the exterior wall section are positioned against one another the first and second cable entrance slits are not aligned with each other.

5. The end cap of claim 1, wherein the end cap further comprises a second longitudinal port extending through the wall member from the first surface to the second surface, the second port having a substantially circular transverse cross-sectional shape configured for receiving a substantially cylindrical cable therethrough.

6. The end cap of claim 1, wherein the wall member further comprises locating means for positioning the wall member within a closure.

7. The end cap of claim 6, wherein the locating means comprise at least one tab projecting from the wall member adjacent the outer circumferential edge, the at least one tab configured for engaging a mating element of the closure.

8. The end cap of claim 1, further comprising at least one flexible sealing lip within the port, the at least one lip projecting from a sidewall of the port and extending around a periphery of at least one of the first and second lobed portions of the port.

9. The end cap of claim 8, wherein the at least one flexible sealing lip angularly projects from the sidewall of the port toward the second surface of the wall member.

10. The end cap of claim 8, wherein the wall member comprises an interior wall section defining the first surface and an exterior wall section defining the second surface, the port extending through both the interior wall section and the exterior wall section, and wherein the at least one flexible sealing lip within the port comprises:
a first flexible lip projecting from the sidewall of the port in the interior wall section; and
a second flexible lip projecting from the sidewall of the port in the exterior wall section.

11. The end cap of claim 1, wherein the lobed transverse cross-sectional shape of the longitudinal port is defined by an inner surface of a hollow elongate member extending through the wall member, the hollow elongate member suspended within the wall member by a flexible transverse skirt extending from an outer surface of the hollow elongate member to the wall member.

12. The end cap of claim 11, wherein the hollow elongate member includes a longitudinal support member positioned at the waist of the cross-sectional shape and extending along the outer surface of the hollow elongate member.

13. The end cap of claim 11, further comprising a flexible sealing lip projecting from the inner surface of the hollow elongate member and extending around a periphery of at least one of the first and second lobed portions of the port.

14. The end cap of claim 13, wherein the flexible transverse skirt extending from the outer surface of the hollow elongate member and the flexible sealing lip projecting from the inner surface of the hollow elongate member are aligned with each other.

15. (canceled)

16. (canceled)

17. The end cap of claim 11, wherein the hollow elongate member extends beyond at least one of the first surface and the second surface of the wall member.

18. An enclosure for a telecommunication cable or conduit having a plurality of telecommunication lines, the enclosure comprising:
a re-enterable compartment for retaining telecommunication line connection devices, the re-enterable compartment including an opening for receiving a telecommunication cable assembly having a lobed cross-sectional shape; and
a sealing member configured for forming a seal around the telecommunication cable assembly; the sealing member comprising:
a wall member having a first surface, a second surface, and an outer circumferential edge configured to sealingly engage the compartment opening; and
a longitudinal port extending through the wall member from the first surface to the second surface, the port having a transverse cross-sectional shape defined by first and second lobed portions joined at a waist, the cross-sectional shape configured for receiving the cable assembly therethrough.

19. The enclosure of claim 18, wherein the sealing member further comprises a second longitudinal port extending through the wall member from the first surface to the second surface, the second port having a substantially circular transverse cross-sectional shape configured for receiving a substantially cylindrical cable therethrough.

20. The enclosure of claim 18, wherein the sealing member further comprises at least one flexible sealing lip within the port, the at least one lip projecting from a sidewall of the port and extending around a periphery of at least one of the first and second lobed portions of the port.

21. The enclosure of claim 18, wherein the lobed transverse cross-sectional shape of the longitudinal port is defined by an inner surface of a hollow elongate member extending through the wall member, the hollow elongate member suspended within the wall member by at least one flexible transverse skirt extending from an outer surface of the hollow elongate member to the wall member.

22. The enclosure of claim 18, wherein the flexible transverse skirt extending from the outer surface of the hollow elongate member and the flexible sealing lip projecting from the inner surface of the hollow elongate member are zigzagged engaged.
